(19) United States
(12) Patent Application Publication
(10) Pub. No.: US 2015/0121887 A1
(43) Pub. Date: May 7, 2015

(54) AUTOMATED CONTROL OF PART-SPEED GAS TURBINE OPERATION

(71) Applicant: General Electric Company, Schenectady, NY (US)

(72) Inventors: Chi Ming Ho, Simpsonville, SC (US); Skigh Elliot Lewis, Pleasant Grove, UT (US); Priscilla Graves Childers, Gray Court, SC (US); David Leach, Simpsonville, SC (US)

(73) Assignee: General Electric Company, Schenectady, NY (US)

(21) Appl. No.: 14/071,127

(22) Filed: Nov. 4, 2013

(51) Int. Cl. F02C 9/32

(52) U.S. Cl. CPC F02C 9/32; F05D 2270/03
USPC 60/772; 60/734

(57) ABSTRACT

A method of controlling operability of a gas turbine during part-speed operation includes identifying that a combustion system of the gas turbine is operating at part-speed, the combustion system including a fuel source, fuel circuits and valves operably interposed between the fuel source and the fuel circuits, respectively, defining first and second boundaries based on first and second parameters and automatically controlling each of the valves to control fuel flow to each of the fuel circuits in accordance with the defined first and second boundaries.

### BACKGROUND OF THE INVENTION

The subject matter disclosed herein relates to gas turbine operations and, more particularly, to automated control of part-speed gas turbine operations to improve flame stability and combustion efficiency in order to affect exhaust temperature spread, combustion dynamics and emissions while not exceeding other boundaries like exhaust temperature limits and acceleration rate limits.

The part-speed operation of a gas turbine is highly transient and subject to large variations due to ambient conditions and the state of the turbine prior to unit start. Additionally, uncertainties in the part-speed air and fuel flows make it particularly challenging to understand part-speed operation. Indeed, while diffusion operation is quite robust and does not require a detailed understanding of the part-speed flows, premix operation is particularly sensitive to these variations.

### BRIEF DESCRIPTION OF THE INVENTION

According to one aspect of the invention, a method of controlling operability of a gas turbine during part-speed operation is provided and includes identifying that a combustion system of the gas turbine is operating at part-speed, the combustion system including a fuel source, fuel circuits and valves operably interposed between the fuel source and the fuel circuits, respectively, defining first and second boundaries based on first and second parameters and automatically controlling each of the valves to control fuel flow to each of the fuel circuits in accordance with the defined first and second boundaries.

According to another aspect of the invention, a method of controlling operability of a gas turbine during part-speed operation is provided and includes identifying that a combustion system of the gas turbine is operating at part-speed, the combustion system including a fuel source, fuel circuits and valves operably interposed between the fuel source and the fuel circuits, respectively, defining lean and rich blow out (LBO and RBO) boundaries based on a fuel nozzle equivalence ratio and a combustor severity parameter and automatically controlling each of the valves to control fuel flow to each of the fuel circuits in accordance with the defined LBO and RBO boundaries.

According to yet another aspect of the invention, a system for controlling operability of a gas turbine during part-speed operation is provided and includes a combustion system, which is operable at part-speed to produce a working fluid from combustion, the combustion system including a fuel source, fuel circuits and valves operably interposed between the fuel source and the fuel circuits, respectively, and a controller. The controller includes encoded data relating to first and second boundaries of the combustion system based on first and second parameters of the combustion system and a processor configured to automatically control each of the valves to control fuel flow to each of the fuel circuits in accordance with the defined first and second boundaries.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic diagram of a gas turbine engine in accordance with embodiments;

FIG. 2 is an enlarged view of a combustor and fuel circuits of the gas turbine engine of FIG. 1;

FIG. 3 is a schematic diagram of a controller of the gas turbine engine of FIG. 1;

FIG. 4 is a flow diagram illustrating a method of controlling operability of a gas turbine during part-speed operation in accordance with embodiments;

FIG. 5 is a flow diagram illustration a detailed method of controlling operability of a gas turbine during part-speed operation in accordance with further embodiments;

FIG. 6 is a graphical depiction of operational boundaries employed by the method of FIG. 4;

FIG. 7 is a graphical depiction of results of an execution of the method of FIG. 5; and

FIG. 8 is a graphical depiction of successful and failed starts of a gas turbine engine.

The detailed description explains embodiments of the invention, together with advantages and features, by way of example with reference to the drawings.

### DETAILED DESCRIPTION OF THE INVENTION

The description provided below relates to part-speed automated control strategy of a gas turbine engine in which a gas turbine control system automatically controls fuel flows to each of the fuel circuits of the gas turbine engine to improve flame stability and combustion efficiency in order to affect exhaust temperature spread, combustion dynamics and emissions while not exceeding other boundaries like exhaust temperature limits and acceleration rate limits.

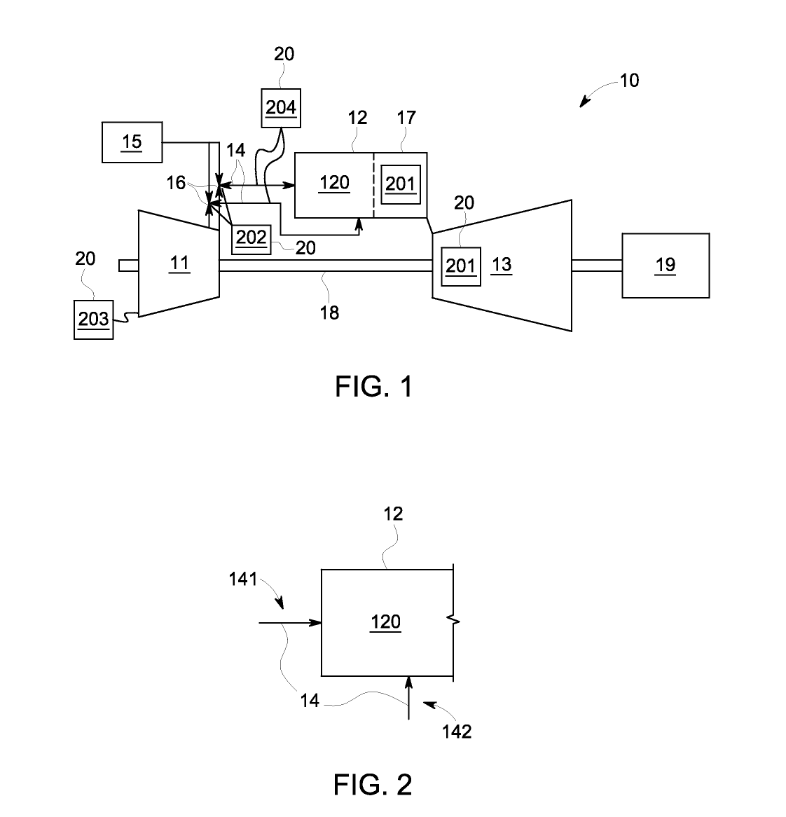

With reference to FIGS. 1 and 2, a gas turbine engine 10 is provided and includes a compressor 11, a combustor 12 and a turbine section 13. The compressor 11 compresses inlet air and outputs the compressed inlet air to the combustor 12 via fuel circuits 14. Although two fuel circuits 14 are shown in FIGS. 1 and 2, it will be understood that one fuel circuit 14 or more than two fuel circuits 14 may be provided in the gas turbine engine 10. The fuel circuits 14 are each receptive of fuel from fuel source 15 via valves 16 that increase or decrease an amount of fuel each fuel circuit 14 receives. Within the fuel circuits 14, the received fuel and the compressed inlet air are mixed and injected into an interior 120 of the combustor 12 as combustible materials. The combustible materials are combusted within the interior 120 and produce a high temperature and high pressure working fluid that is directed into the turbine section 13 by way of a transition piece 17, which is fluidly interposed between the combustor 12 and the turbine section 13. Some of the fuel circuit 14 may be disposed to inject the combustible materials into an interior of the transition piece 17 as part of a late lean injection (LLI) system that may be provided with the gas turbine engine 10. Within the turbine section 13, the high temperature and high pressure working fluid is expanded to produce mechanical energy that drives rotation of a rotor 18 extending through the turbine section 13, the compressor 11 and a generator 19. The rotation of the rotor 18 drives an operation of the compressor 11 and may be employed in the production of electricity in the generator 19.

In accordance with embodiments and, as shown in FIG. 2, the fuel circuits 14 may include first fuel circuit (PM1 circuit) 141 and second fuel circuit (PM2 circuit) 142. The PM1 circuit 141 feeds a center fuel nozzle in the combustor 12, or in a can-annular array, the center fuel nozzle in each of the combustor 12 cans. The PM2 circuit 142 feeds two of the five outer fuel nozzles in the combustor 12 or, in the case of the can-annular array, two of the five outer fuel nozzles in each of the combustor 12 cans.

The gas turbine engine 10 may further include multiple sensors 20 disposed throughout the compressor 11, the combustor 12 and the turbine section 13. The sensors 20 may include temperature sensors 201, such as thermocouples disposed in the exhaust stream of the combustor 12 to detect exhaust temperatures and in wheelspace cavities in the turbine section 13 to detect temperatures in the wheelspace cavities. The sensors 20 may also include position sensors 202 disposed to provide feedback of the valve stroke of the valve 16, pressure sensors 203 disposed in an inlet (e.g., a bell mouth shaped inlet) of the compressor 11 to measure compressor inlet air flows and pressure and/or flow measurement sensors 204 disposed in the fuel circuits 14 to detect static and dynamic pressures of at least the fuel received in the fuel circuits 14 and to measure fuel flow rates. Taken together, the readings of the sensors 20 provide a picture of cycle conditions, such as pressures, temperatures, air flow and fuel flow, within the gas turbine engine 10 throughout operation.

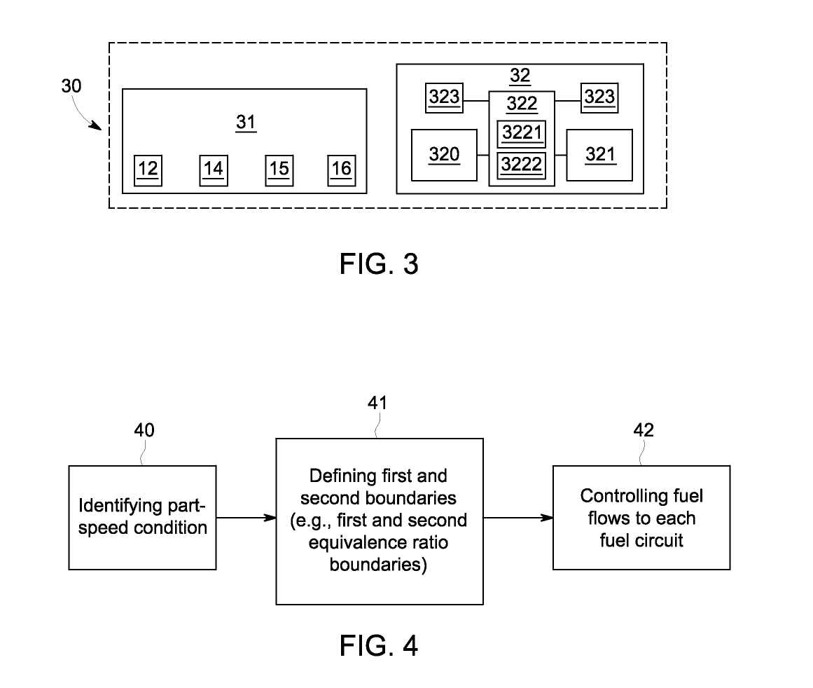

The gas turbine engine 10 of FIGS. 1 and 2 is operable in multiple modes and at multiple speeds under loaded (i.e., full load or FL) or unloaded (i.e., no load or NL) conditions. In particular, the gas turbine engine 10 may be started from a zero-speed condition and accelerated through a part-speed condition over several minutes before reaching a full-speed condition. Operability of the gas turbine engine 10 of FIGS. 1 and 2 may be subject to operational boundaries associated with the combustion system 31 (see FIG. 3), which includes the combustor 12, the fuel circuits 14, the fuel source 15 and the valves 16.

For example, with the configuration of the PM1 circuit 141 and the PM2 circuit 142 described above, there may be three or more operational boundaries for controlling equivalence ratio of fuel nozzles. These include a lean blow out (LBO) boundary on fuel nozzle equivalence ratio for the PM1 circuit 141, a rich blow out (RBO) boundary on fuel nozzle equivalence ratio for the PM1 circuit 141 and a third boundary on fuel nozzle equivalence ratio for the PM2 circuit 142. This third boundary is referred to as an attach/detach (A/D) boundary, near which the PM2 circuit 142 flame will exhibit transient behavior by attaching and detaching to the fuel nozzle tip thereby generating high combustion dynamics and instability. Alternatively, the RBO boundary for the PM1 circuit 141 may be combined with limits based on combustion cap metal temperatures or emissions. Moreover, if one only considers the A/D boundary of the PM2 circuit 142, the A/D boundary may be combined with limits based on cross-fire tube temperatures and combustion dynamics.

During operations associated with the part-speed condition, the primary concerns for operability are complete or partial blow out, overheating, excess combustion dynamics amplitude, low combustion efficiencies and excess acceleration. Complete or partial blow out of the flame in one or more combustor 12 cans may lead to high exhaust temperature spreads and may cause the gas turbine engine 10 to trip. One of the causes for such blow out is related to variations in fuel and/or air flow that cause the fuel nozzles to cross their respective boundaries (e.g., the PM1 circuit 141 fuel nozzle equivalence ratio exceeds its LBO or RBO boundary or the PM2 circuit 142 fuel nozzle equivalence ratio crosses the attachment/detachment boundary). Overheating occurs when the PM2 circuit 142 fuel nozzle equivalence ratio becomes too high, combustion dynamics amplitudes in certain frequency range may exceed the acceptable limit for certain parts of the combustor 12, low combustion efficiencies can generate high level of CO and UHC, which can become an issue as emissions regulations become stricter and, at low speed range before the gas turbine engine 10 transitions to acceleration control, acceleration may exceed its limit if too much fuel is commanded. That is, when the gas turbine engine 10 is on acceleration control, the amount of fuel required to follow the acceleration schedule may push the exhaust temperature to its limit.

With reference to FIG. 3, a system 30 is provided for controlling the operability of the gas turbine engine 10 of FIG. 1 during operations associated with the part-speed condition. As shown in FIG. 2, the system 30 includes the combustion system 31, which is operable at part-speed to produce a working fluid from combustion, and a controller 32. The controller 32 includes a computer-readable medium 320 on which encoded data 321 is stored, a processor 322 and servo units 323 associated with and operably coupled to each of the fuel circuits 14 and each of the valves 16. The encoded data 321 may relate to first and second operational boundaries of the combustion system 30 (e.g., the lean blow out (LBO) boundary on fuel nozzle equivalence ratio for the PM1 circuit 141 and the rich blow out (RBO) boundary on fuel nozzle equivalence ratio for the PM1 circuit 141), which are based on first and second parameters of the combustion system 30. The processor 322 is configured to access the encoded data 321 and to manipulate the servo units 323 in order to automatically control each of the valves 16.

The control allows the processor 322 to control fuel flows to each of the fuel circuits 14 in accordance with the defined first and second operational boundaries of the combustion system 30. The control also allows the processor 322 to apply respective biases toward one or both of the PM1 circuit 141 and the PM2 circuit 142 equivalence ratios. The biases allow for tuning to account for machine-to-machine variations in, e.g., air flow calculations.

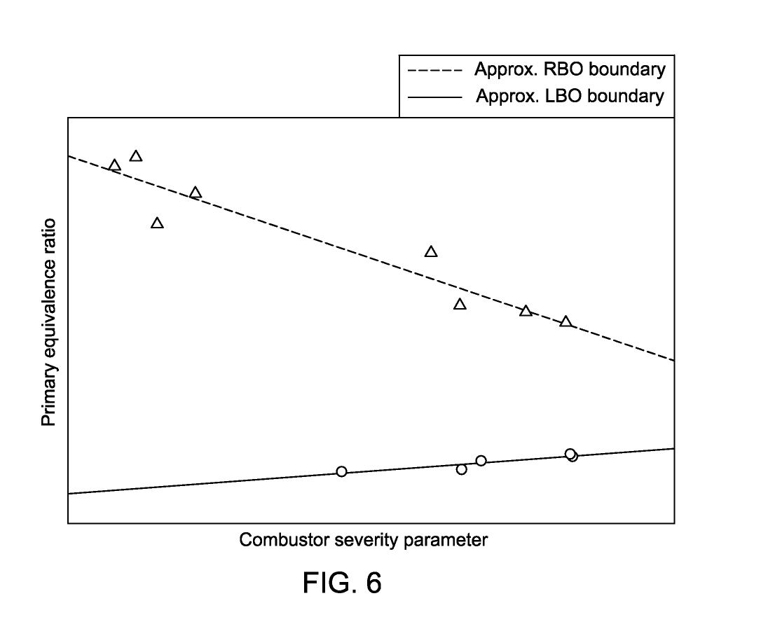

With reference to FIGS. 4-8, the processor 322 may be configured to identify that the combustion system 30 of the gas turbine engine 10 is operating at the part-speed condition (operation 40). In such a case, the processor 322 accesses the encoded data 321 and from the encoded data 321 defines at least the first and second operational boundaries, such as PM1 circuit 141 (see FIG. 6) and PM2 circuit 142 equivalence ratio boundaries, based on the first and second parameters (operation 41) and may define additional operational boundaries based on the first and second parameters as well as other parameters (e.g., the third boundary on fuel nozzle equivalence ratio for the PM2 circuit 142). The first and second operational boundaries form a part-speed model that can be used to generate real-time predictions of the cycle conditions for operational control of the gas turbine engine 10.

With the part-speed model formed from the first and second operational boundaries and usable to generate the real-time predictions of the cycle conditions, the processor 322 relates the first and second boundaries to the fuel flows in the fuel circuits 14 via first and second transfer functions, respectively, and manipulates the servo units 323 to automatically control each of the valves 16 to control the fuel flows to each of the fuel circuits 14 in accordance with the defined first and second operational boundaries and the first and second transfer functions (operation 42). The resulting control of the fuel flows to each of the fuel circuits 14 permits the processor 322 to maintain and if necessary improve margins associated with the first and second operational boundaries.

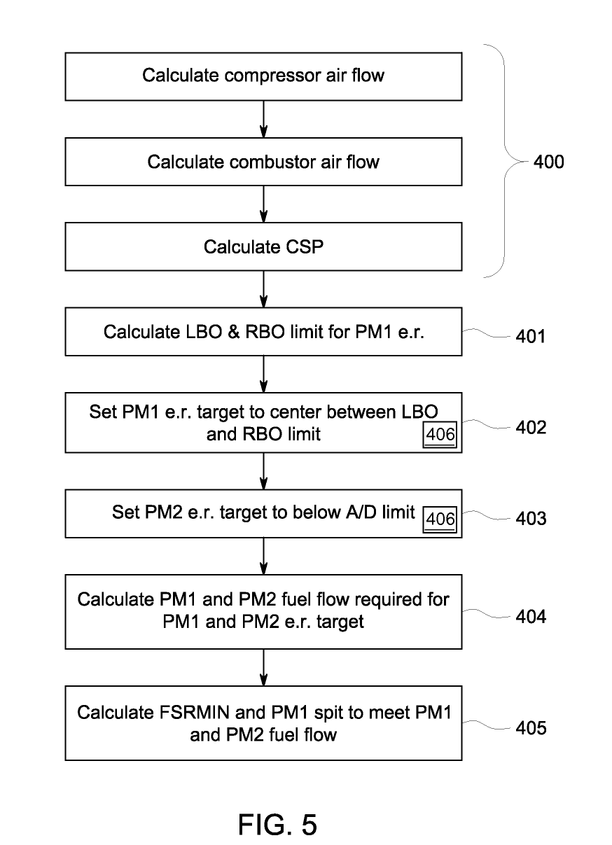

In greater detail and, with reference to FIG. 5, the processor 322 may calculate compressor and combustor air flows as well as a combustion severity parameter (operation 400). At this point, the processor 322 calculates LBO and RBO limits for the PM1 circuit 141 (operation 401) and may set the PM1 circuit 141 equivalence ratio target to a center between the LBO and RBO limits (operation 402) in accordance with a closed loop control strategy. The processor 322 then sets the PM1 circuit 142 equivalence ratio target to a predefined value or to a value defined as being less than the A/D limit (operation 403) and calculates PM1 circuit 141 and PM2 circuit 142 fuel flows required for the set targets (operation 404). At this point, the processor 322 calculates fuel split ratios to meet the calculated fuel flows (operation 405). One or both of operations 402 and 403 may further include an application of a bias (406) to the equivalence ratio targets by the processor 322 in order to allow for tuning to account for machine-to-machine variations in, e.g., air flow calculations.

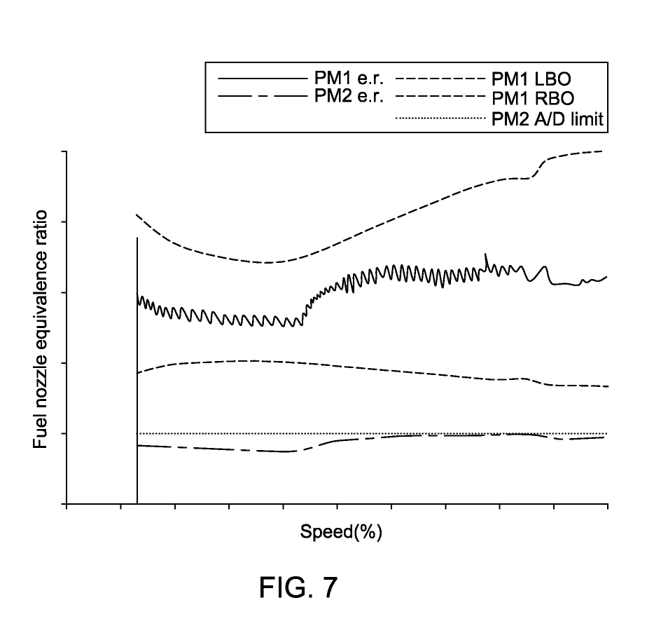

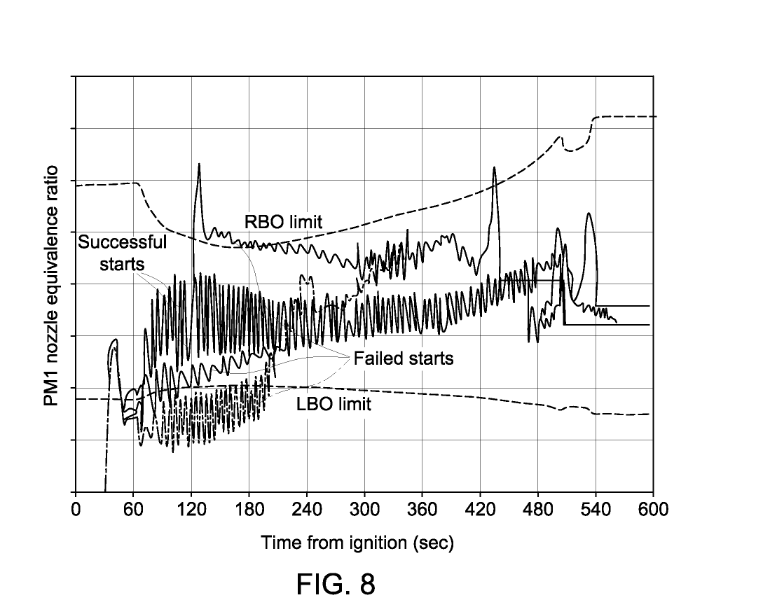

That is, with reference to FIGS. 6 and 7, the resulting control allows the processor 322 to control the operation of the gas turbine engine 10 such that the first and second operational boundaries are not approached or breeched, which leads to an increased likelihood of a successful start as shown in FIG. 8.

As noted above and, in accordance with embodiments, the first operational boundary may be associated with a rich blow out margin (RBO) of the combustion system 30 and the second operational boundary may be associated with a lean blow out (LBO) margin of the combustion system 30. In accordance with further embodiments and, as shown in FIG. 4, the first and second parameters may include a fuel nozzle equivalence ratio, which is obtained by dividing a local fuel-air ratio by a stoichiometric fuel-air ratio, and a combustor severity parameter, respectively. Alternative or additional examples of the first and second operational boundaries may be associated with exhaust temperature spreads, combustion dynamics, combustion efficiencies, metal temperature limits for fuel nozzles, caps, cross fire tubes, liners, blank cartridges, liquid fuel cartridges, etc., exhaust temperatures and/or acceleration rates or total acceleration times. In each case, the first and second parameters may be characteristics of the combustion system 30 that are associated with or otherwise define these alternative or additional examples.

In accordance with additional embodiments, the processor 322 may be configured to control combustion efficiency of the combustion system 30 in order to maintain operability margins and improve emissions performance. The processor 322 may also include logic 3221 (see FIG. 2) to vary warm-up times of the combustion system 30 based upon wheelspace temperatures sensed by the sensors 20 disposed in the wheelspace of the turbine section 13. Warm-up times occur after ignition and crossfire and, for a cold start (where the average wheelspace temperature is less than, e.g., approximately 150 degF), the processor 322 will control the combustion system 30 to warm up for 2-2.5 minutes. For a hot start (where the average wheelspace temperatures are greater than, e.g., approximately 450 degF), the processor 322 will control the combustion system 30 to warm up for 1-4 minutes. For average wheelspace temperatures between, e.g., approximately 150-450 degF, the processor 322 will control the warm-up time to have a linear interpolation from approximately 2 or 2.5-4 minutes. The variable warm-up times will improve combustion efficiency and emissions performance for a cold start but, for a hot start, will not risk exceeding exhaust temperature limits.

In accordance with still further embodiments, the processor 322 may include additional logic 3222 (see FIG. 2) for closed-loop acceleration control that will allow the processor 322 to control the gas turbine engine 10 and the combustion system 30 to accelerate consistently. Such consistent acceleration will improve rotor life and will decrease a risk of damage to the compressor 11 and the turbine section 13. In particular, the processor 322 may control the fuel flows to the fuel circuits 14 in order to maintain a specified acceleration rate throughout at least startup.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of controlling operability of a gas turbine during part-speed operation, the method comprising:
identifying that a combustion system of the gas turbine is operating at part-speed, the combustion system including a fuel source, fuel circuits and valves operably interposed between the fuel source and the fuel circuits, respectively;
defining first and second boundaries based on first and second parameters; and
automatically controlling each of the valves to control fuel flow to each of the fuel circuits in accordance with the defined first and second boundaries.

2. The method according to claim 1, wherein the defining comprises defining additional boundaries based on at least the first and second parameters.

3. The method according to claim 1, wherein the first boundary is associated with a rich blow out margin (RBO) of the combustion system and the second boundary is associated with a lean blow out (LBO) margin of the combustion system and wherein the first and second parameters comprise a fuel nozzle equivalence ratio and a combustor severity parameter, respectively.

4. The method according to claim 1, wherein the first boundary is associated with a rich blow out margin (RBO) of a center fuel nozzle circuit of the combustion system and the second boundary is associated with combustion cap metal temperatures or emissions.

5. The method according to claim 1, wherein the first boundary is associated with an attach/detach limit of an outer fuel nozzle circuit of the combustion system and the second boundary is associated with cross-fire tube temperatures and combustion dynamics.

6. The method according to claim 1, further comprising relating the first and second boundaries to the fuel flow via first and second transfer functions, respectively.

7. The method according to claim 1, further comprising automatically controlling each of the valves to control fuel flow to each of the fuel circuits in order to maintain combustion efficiency,
wherein the automatically controlling of each of the valves comprises applying closed loop control to a target defined between the first and second boundaries.

8. The method according to claim 7, further comprising applying a bias to the target.

9. The method according to claim 1, further comprising varying a warm-up time based on wheelspace temperatures.

10. The method according to claim 1, further comprising controlling the combustion system to maintain a predefined acceleration rate.

11. A method of controlling operability of a gas turbine during part-speed operation, the method comprising:
identifying that a combustion system of the gas turbine is operating at part-speed, the combustion system including a fuel source, fuel circuits and valves operably interposed between the fuel source and the fuel circuits, respectively;
defining lean and rich blow out (LBO and RBO) boundaries based on a fuel nozzle equivalence ratio and a combustor severity parameter; and
automatically controlling each of the valves to control fuel flow to each of the fuel circuits in accordance with the defined LBO and RBO boundaries.

12. A system for controlling operability of a gas turbine during part-speed operation, the system comprising:
a combustion system, which is operable at part-speed to produce a working fluid from combustion, the combustion system including a fuel source, fuel circuits and valves operably interposed between the fuel source and the fuel circuits, respectively; and
a controller comprising encoded data relating to first and second boundaries of the combustion system based on first and second parameters of the combustion system and a processor,
the processor being configured to automatically control each of the valves to control fuel flow to each of the fuel circuits in accordance with the defined first and second boundaries.

13. The system according to claim 12, wherein the first boundary is associated with a rich blow out margin (RBO) of the combustion system and the second boundary is associated with a lean blow out (LBO) margin of the combustion system.

14. The system according to claim 13, wherein the first and second parameters comprise a fuel nozzle equivalence ratio and a combustor severity parameter, respectively.

15. The system according to claim 14, wherein the first and second boundaries are based on the first and second parameters and additional terms.

16. The system according to claim 15, wherein the fuel nozzle equivalence ratio comprises a local fuel-air ratio divided by a stoichiometric fuel-air ratio.

17. The system according to claim 12, wherein the processor is further configured to relate the first and second boundaries to the fuel flow via first and second transfer functions, respectively.

18. The system according to claim 12, wherein the processor is further configured to automatically control each of the valves to control fuel flow to each of the fuel circuits in order to maintain combustion efficiency.

19. The system according to claim 12, wherein the processor is further configured to vary a warm-up time based on wheelspace temperatures.

20. The system according to claim 12, wherein the processor is further configured to control the combustion system to maintain a predefined acceleration rate.
